(19) United States
(12) Patent Application Publication
(10) Pub. No.: US 2003/0194921 A1
(43) Pub. Date: Oct. 16, 2003

(54) Universal boat motor mount for mounting and controlling an electric trolling motor

(76) Inventors: Peter Leiss, Somerset, PA (US); Denver L. Barker JR., Somerset, PA (US)

Correspondence Address: CAROTHERS AND CAROTHERS, Suite 500, 445 Fort Pitt Blvd., Pittsburgh, PA, 15219, US

(21) Appl. No.: 10/122,749

(22) Filed: Apr. 15, 2002

(51) Int. Cl. B60L 11/02; B60L 11/16; B60L 11/18; B63H 21/17

(52) U.S. Cl. 440/6

(57) ABSTRACT

A universal boat motor mount for mounting and controlling an electric trolling motor. A mounting plank is detachably secured to spaced side gunnels of a small boat with a portion of the plank overhanging a side of the boat. The overhanging portion of the plank is provided with a motor mount bracket for mounting a trolling motor and the motor mount bracket is rotatable relative to the plank to steer the trolling motor. A steering drive is also secured to the plank and includes a steering coupling which couples the steering drive to the motor bracket for steering a trolling motor mounted on the bracket. A transmission control is also secured to the plank and includes a transmission coupling for coupling the transmission control to the electric trolling motor to switch the drive direction of the motor. A remote control, such as a hand operated control or foot control, is utilized for remotely controlling the steering drive and the transmission control.

### FIELD OF THE INVENTION

The present invention relates in general to trolling motors for small boats or water craft, and more particularly to a universal motor mount for mounting and controlling such electric trolling motors.

### BACKGROUND OF THE INVENTION

Trolling motors are used by fisherman, hunters and other boaters as a motor to quietly propel the boat short distances and to provide precise positioning of the boat. Most recent steering and directional control systems for trolling motors include radio frequency control, optical control, voice recognition computer control systems or direct hardwired controls, which are operated either by hand or by one's foot.

The existing problem with these remote control systems is that they are designed whereby the control systems only operate with a particular trolling motor and the boater must therefore purchase the corresponding electric trolling motor or change an existing motor to meet the demands.

In using these small electric trolling motors the remote controls control the speed and direction of the motor as well as starting and stopping of the motor with one's hands or feet. These motors have a propeller and work off a low voltage DC battery, usually 12 or 24 volts.

A portion of the controls and electronics are usually built within the trolling motor itself and the user therefore cannot use their existing trolling motor with a new set of remote controls. Also, if any malfunction occurs in the controls or the electronics, the trolling motor itself is useless. In addition, most of the existing electric trolling motors with foot or hand remote controls are much too large and powerful to use on very light boats, such as canoes or other small water craft.

It is a principal object of the present invention to eliminate these aforementioned disadvantages.

### SUMMARY OF THE INVENTION

The universal motor mount of the present invention permits small boaters to incorporate full remote capabilities for most any existing trolling motor and therefore permits the user to purchase a small inexpensive trolling motor of their choosing. With the universal motor mount of the present invention, the electric trolling motor mount itself is provided with steering and control electronics built into the mount itself and nothing has to be changed on an existing trolling motor to allow it to be controlled by the universal mount of the present invention.

The universal boat motor mount of the present invention is provided for mounting and controlling an electric trolling motor and includes a basic frame structure referred to as a plank means which may be in the form of a plank or a frame member which has securing means for detachably securing the plank means to spaced side gunnels of the boat with a portion of the plank or frame overhanging a side of the boat. The overhanging portion of the plank is provided with a motor mount bracket which is secured for mounting a trolling motor thereon. The motor mount bracket is rotatable relative to the plank or plank means about a vertical axis for steering a trolling motor mounted thereon.

A steering drive is secured to the plank means and includes a steering coupling which couples the steering drive to the motor mount bracket for steering a trolling motor mounted on the motor mount bracket. In addition, a transmission control is also secured to the plank and includes a transmission coupling means, which may be mechanical, electro mechanical or electrical etc., for coupling the transmission control to the trolling motor mounted on the motor mount bracket to switch the drive direction of the motor. In addition, this control may also be used to switch the motor on or off and to vary the speed of the motor.

A remote control means in the form of a hand control or foot control which is directly wired, or utilizes radio frequency transmissions or optical transmission etc. is used for remotely controlling the steering drive and the transmission control.

The mount of the present invention accordingly allows right and left steering of the electric trolling motor as well as forward on, off, reverse on, and off positions. A lift out may be also provided if desired for the motor to lift the motor out of the water and down into the water. Accordingly, all of the advantages of the larger more expensive remote control trolling motors are incorporated into the universal mount of the present invention and the user need only to connect the two leads from the trolling motor to the remote mount of the present invention.

In addition, the universal mount of the present invention provides the additional feature that in the event that something occurs to the electronics or mechanical parts of the system, the operator is free to continue to use their motor as a traditional trolling motor.

### BRIEF DESCRIPTION OF THE DRAWINGS

Other objects and advantages appear hereinafter in the following description and claims. The appended drawings show, for the purpose of exemplification, without limiting the invention or appended claims, certain practical embodiments of the present invention wherein:

FIG. 1 is a perspective view of the universal motor mount of the present invention as applied to a canoe; and

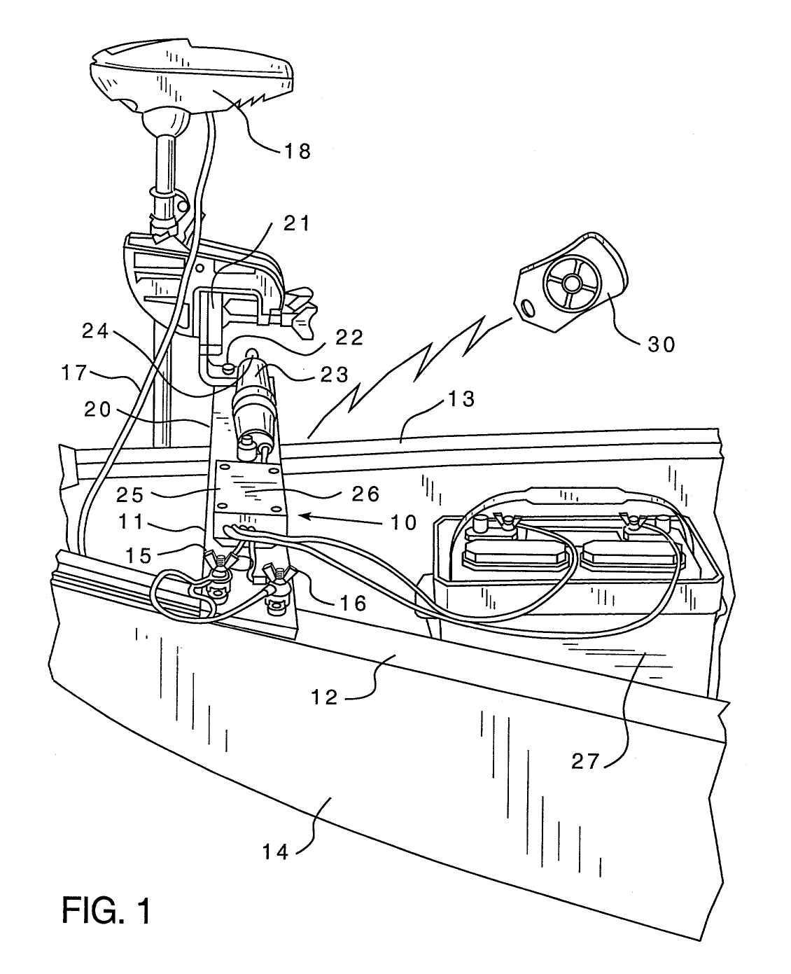

FIG. 2 is a perspective view of a foot-operated transmitter used as a remote control for the trolling motor of FIG. 1 in lieu of the handheld transmitter shown in FIG. 1.

### DETAILED DESCRIPTION OF A PREFERRED EMBODIMENT

Referring to the drawings, the universal boat motor mount 10 of the present invention is provided with plank means 11, which is shown here in the form of a plastic or wooden plank, but of course may be of any useful structure, such as a metal frame, which is detachably secured to the spaced side gunnels 12 and 13 of small boat or canoe 14, which has end portions broken away for conserving space in the drawing.

In this configuration, the securing means is provided in the form of bolts 15 and 16 which pass through plank 11 and gunnel 12 and are threadably secured to maintain plank means 11 in tight engagement with gunnel 12. Bolts 15 and 16 also serve as electrical terminals for connection of the electric control line pair 17 to conventional electric controlling motor 18.

Plank means 11 is so mounted across the gunnels 12 and 13 of canoe 14 such that it is provided with an overhanging portion 20 which overhangs the side of canoe 14. A motor mount bracket 21 is secured to the overhanging portion 20 for mounting trolling motor 18 thereon as illustrated. Motor mount bracket 21 is rotatable relative to plank means 11 about vertical axis 22 for steering trolling motor 18.

A steering drive 23 is secured to plank means 11 and includes a steering coupling arm 24 which couples steering drive 23 to motor bracket 21 for steering trolling motor 18 mounted thereon. This steering drive 23 is an electro mechanical device of conventional structure which houses a bidirectional DC electric motor and correspondingly extends or retracts steering coupling arm 24 to steer the bracket 21 and correspondingly the motor 18 mounted thereon.

A transmission control 25 is also secured to plank means 11 and includes a transmission coupling in the form of electric wire pair 17 for coupling the control 25 to electric trolling motor 18. Electric trolling motor 18 is of a conventional type and already includes electro mechanical devices therein for turning the motor on and off, and for turning the motor forward on and reverse on. This is all accomplished through the electric transmission signal sent by transmission control 25 through wire pair 17.

Transmission control 25 also includes a receiver 26 which is a radio frequency receiver for receiving command signals from remote handheld control 30. Transmission control and receiver 26 and steering drive 23 are all electrically energized through the connected 12 volt conventional battery 27.

The exact type and nature of receiver 26, drive control 25 and steering drive 23 is not critical to the present invention. As previously stated, these are conventional electric and electro mechanical devices readily found on the market and in the prior art.

The same also holds true with regard to handheld remote control 30 which is a conventional handheld transmitter that contains a 9 volt DC battery and concludes a power on-off switch and another switch for remotely controlling motor 18 in a left turn and right turn and switches for increased and decreased power. This RF transmitter is for example of the same type as illustrated in U.S. Pat. No. 4,614,900. Similarly, the receiver 26 and drive control 25 may also be of the same type as illustrated in this patent.

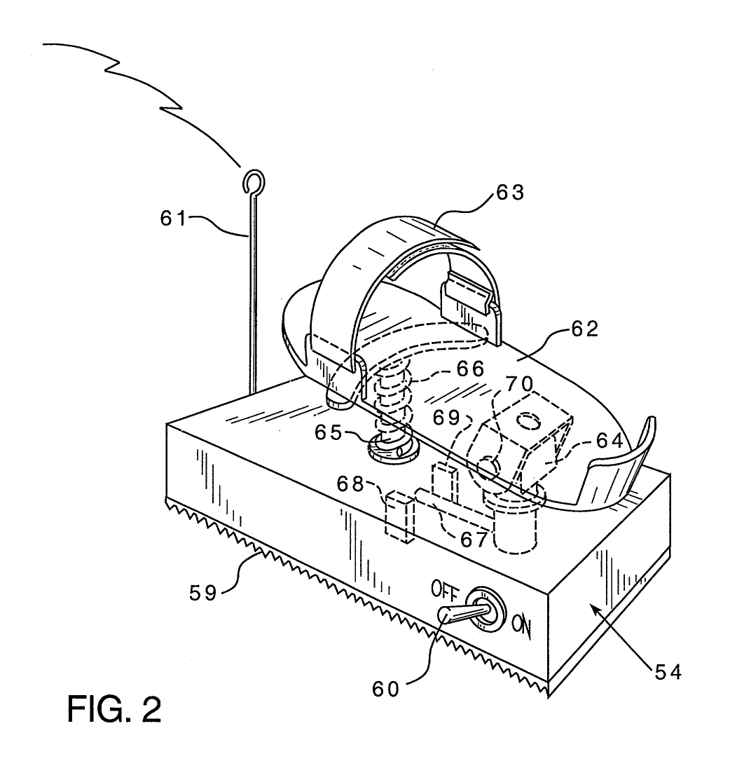

The remote control 30 may also be substituted for a remote foot control as illustrated in FIG. 2. Here the foot operated transmitter 54 has an anti-skid tread pad 59 covering its bottom face, a power on-off switch 60 connected with the internal 9 volt battery of the transmitter and a matched antenna 61. Additionally, a foot treadle 62 preferably equipped with an adjustable foot strap 63 is held near its rear end on a universal swivel mount 64. Near its forward end, the foot treadle is connected to a depressable trolling motor on-off switch actuator 65, biased to an off position by a spring 66. A side-to-side swinging actuator rod 67 on the swivel mount can engage selectively actuator 68 and 69 of the left turn and right turn switches 40 and 41. The foot treadle is swung vertically by the foot of the user on the cross axis element 70 of the universal swivel 64, and the foot treadle is swung horizontally with the actuator rod 67 on the vertical axis of the universal swivel 64. This is all in accordance with the prior art teachings of the aforesaid U.S. Pat. No. 4,614,900.

Of course, other remote controls and control systems may be substituted. Instead of RF frequency controllers, the remote controllers may be directly hard wired or the systems may operate by computer or by infrared or other optical transmissions.

What has been described is a universal trolling motor mount which may be adapted for use by any existing electric trolling motor for a small water craft.

We claim:

1. A universal boat motor mount for mounting and controlling an electric trolling motor, the mount comprising:
plank means having securing means for detachably securing said plank means to spaced side gunnels of a boat with a portion of said plank means overhanging a side of the boat;
said overhanging portion of said plank means having a motor mount bracket secured thereto for mounting a trolling motor thereon, said motor mount bracket being rotatable relative to said plank means about a vertical axis for steering a trolling motor mounted thereon;
a steering drive secured to said plank means and including a steering coupling which couples said steering drive to said motor mount bracket for steering a trolling motor mounted thereon;
a transmission control secured to said plank means and including a transmission coupling means for coupling said transmission control to a trolling motor mounted on said motor mount bracket to switch the drive direction thereof; and
remote control means for remotely controlling said steering drive and said transmission control.

2. The universal motor mount of claim 1 wherein said remote control means is a foot controlled remote control.

3. The universal motor mount of claim 1 wherein said remote control means is a handheld remote control.

4. The universal motor mount of claim 1 wherein said steering drive is electro-mechanical and said transmission control and transmission coupling means are electrical.

5. The universal motor mount of claim 4 including a battery electrically connected to said steering drive and said transmission control.

6. The universal motor mount of claim 1 wherein said transmission coupling means is coupled to a trolling motor for also switching the coupled motor on and off.
